(19) United States
(12) Patent Application Publication
(10) Pub. No.: US 2021/0173815 A1
(43) Pub. Date: Jun. 10, 2021

(54) AUTOMATICALLY DISPOSITIONING OF COPIES OF DATA

(71) Applicant: International Business Machines Corporation, Armonk, NY (US)

(72) Inventors: Asimuddin Kazi, Naperville, IL (US); Ethan Wozniak, Cook, IL (US)

(21) Appl. No.: 16/702,754

(22) Filed: Dec. 4, 2019

(51) Int. Cl. G06F 16/178; G06F 3/06

(52) U.S. Cl. CPC G06F 16/178; G06F 3/067; G06F 3/0604; G06F 3/0647

(57) ABSTRACT

A method for dispositioning copies of data. The method includes one or more computer processors identifying data that has been added to a first data storage vault, of a set of data storage vaults, and the data is not stored in another vault. The method further includes determining a dictated number of copies of the data to create based on configuration information related to storing data within the set of data storage vaults. The method further includes creating the dictated number of copies of the data within the first vault. The method further includes assigning an expiration duration value to a first copy of data and the data. The method further includes responding to determining that the first copy data is stored within the first vault for a duration that exceeds the assigned expiration duration value, by deleting the first copy of the data from within the first vault.

### BACKGROUND OF THE INVENTION

The present invention relates generally to the field of data storage, and more particularly dispositioning copies of data within a storage network.

Cloud computing is an information technology paradigm that enables ubiquitous access to shared pools of configurable computing resources over the Internet, such as computational resources, storage resource, and software applications and services. Cloud computing utilizes distributed computing resources to increase computational performance, improve reliability/availability of computing resources, reduce response times, and utilize various techniques to ensure the integrity and security of data stored on the cloud. For example, cloud computing providers can provide individuals, providers of Internet-based services, and companies high-capacity cloud-storage solutions via an infrastructure as a service (IaaS) model.

The physical storage of data within the cloud can span multiple servers at differing locations, which are typically owned and managed by a service provider (i.e., a hosting company). Some cloud storage solutions can utilize various techniques and algorithms to secure data and can further utilize object storage to store and organize the data. Other cloud storage solutions enhance performance associated with accessing and utilizing data.

### SUMMARY

According to an aspect of the present invention, there is a method, computer program product, and/or system for dispositioning copies of data. In an embodiment, the method includes at least one computer processor identifying data that has been added to a first data storage vault, of a set of data storage vaults, and the data is not stored in another vault. The method further includes one computer processor determining a dictated number of copies of the data to create based on configuration information related to storing data within the set of data storage vaults. The method further includes one computer processor creating the dictated number of copies of the data within the first vault. The method further includes one computer processor assigning an expiration duration value to a first copy of data and the data. The method further includes one computer processor responding to determining that the first copy data is stored within the first vault for a duration that exceeds the assigned expiration duration value, by deleting the first copy of the data from within the first vault.

### BRIEF DESCRIPTION OF THE DRAWINGS

FIG. 1 illustrates a networked-computing environment, in accordance with an embodiment of the present invention.

FIG. 2 depicts a flowchart of steps of a copy management program, in accordance with an embodiment of the present invention.

FIG. 3 depicts a flowchart of steps of archive data access program, in accordance with an embodiment of the present invention.

FIG. 4 is a block diagram of components of a computer, in accordance with an embodiment of the present invention.

FIG. 5 depicts a cloud computing environment, according to an embodiment of the present invention.

FIG. 6 depicts a set of functional abstraction layers of a cloud computing environment, according to an embodiment of the present invention.

### DETAILED DESCRIPTION

Embodiments of the present invention recognize that network-accessible, distributed storage architectures are computing capabilities that are offered by cloud computing providers. In particular, a user of cloud computing services may store, retrieve, and utilize data within cloud infrastructure, such as a dispersed storage network (DSN) maintained by a cloud computing provider. Cloud storage enables a user, via one or more computers or computing systems, to store files, applications, etc., on an Internet-based storage system. As referred to herein, a user may represent an individual; another entity, such as a business, a university, an enterprise, an organization, etc.; or another computing system or software application.

Embodiments of the present invention recognize that object storage is one of the storage architectures utilized by cloud storage providers. Object storage is a computer data storage architecture that manages data as objects. Each object typically includes the data itself, a variable amount of metadata, and a globally unique identifier. As referred to herein, data and objects can be used interchangeable.

Embodiments of the present invention recognize that some cloud storage architecture and/or DSNs utilize erasure coding and information dispersal algorithms (IDAs) to break files into unrecognizable segments or slices that are distributed and stores data within a pool of distributed storage systems. Erasure coding of data slices improves the integrity of the data stored in the cloud and allows reconstruction of the data without requiring that all the slices of data are available, such as corrupted data slices or loss of connectivity to a storage node. Embodiments of the present invention also recognize that data access is improved by creating multiple copies of each slice of data and distributing the slices of data that comprise an object among a plurality of storage nodes or storage systems within a cloud storage architecture.

However, embodiments of the present invention recognize that maintaining copies of slices of data when the data is not accessed, or usage drops below a threshold, wastes computing resources and can cause a user to incur additional costs. Embodiments of the present invention utilize a vault architecture to store and organize data objects. Vaults are logical storage container for data objects that are contained within a storage pool. Vaults span multiple device sets and data is automatically spread across all the device sets within the storage pool to optimize access speeds. Some embodiments of the present invention utilize a set of three vaults: an active vault, a RECON (e.g., reconstruction) vault, and an archive vault, for storing data and objects of a user.

Embodiments of the present invention utilize fanout copies of data (e.g., sets of data slices) within a vault of a user to improve various performance metrics related to utilizing the data, as opposed to data replication, which is utilized for protecting and/or backing up data. Performance metric improvements may include increased bandwidth, reduced access time, avoiding delays related to reconstructing the data if one or more slices of the data are lost or corrupted, etc. The fanout copies of data are distributed among a plurality of storage nodes and/or storage systems within a storage pool (e.g., a DSN, a cloud storage system, etc.). Embodiments of the present invention automatically disposition (e.g., delete) fanout copies of the data by assigning an expiration duration value to a metadata parameter associated with a file; a plurality of slices, extents, blocks, or other data storage elements that comprise the data; or other object storage structure. Thereby, releasing data storage resources associated with a user.

In addition, embodiments of present invention can automatically save one instance of the data from among the plurality of fanout copies of the data within the vault structure as an archival copy of the data. In response to a user accessing an archival copy of the data as opposed to the user generating or downloading a new version of the data, other embodiments of the present invention copy the archival copy of the data to the RECON vault of the user, while maintaining the archival copy of the data within the vault that originated the archival copy.

A further embodiment of the present invention can assign differing expiration duration values to fanout copies of the data, so that the number of fanout copies can change based on dictates of a user or usage considerations determined by the user. In addition, an embodiment of the present invention can respond changes related to the usage of the data, such as maintain a performance metric by dynamically updating (e.g., increasing or decreasing) the expiration duration values assigned to one or more fanout copies. Similarly, another embodiment of the present invention can maintain a performance metric by creating additional fanout copies of the data with corresponding expiration duration values to replace fanout copies that are deleted in response to exceeding the corresponding expiration durations for one or more fanout copies. A different embodiment of the present invention can respond to a determination that the storage pool is resource constrained or an administrative dictate by creating fewer fanout copies and/or assigning shorter expiration duration to the fanout copies of the data.

The descriptions of the various scenarios, instances, and examples related to the present invention have been presented for purposes of illustration but are not intended to be exhaustive or limited to the embodiments disclosed.

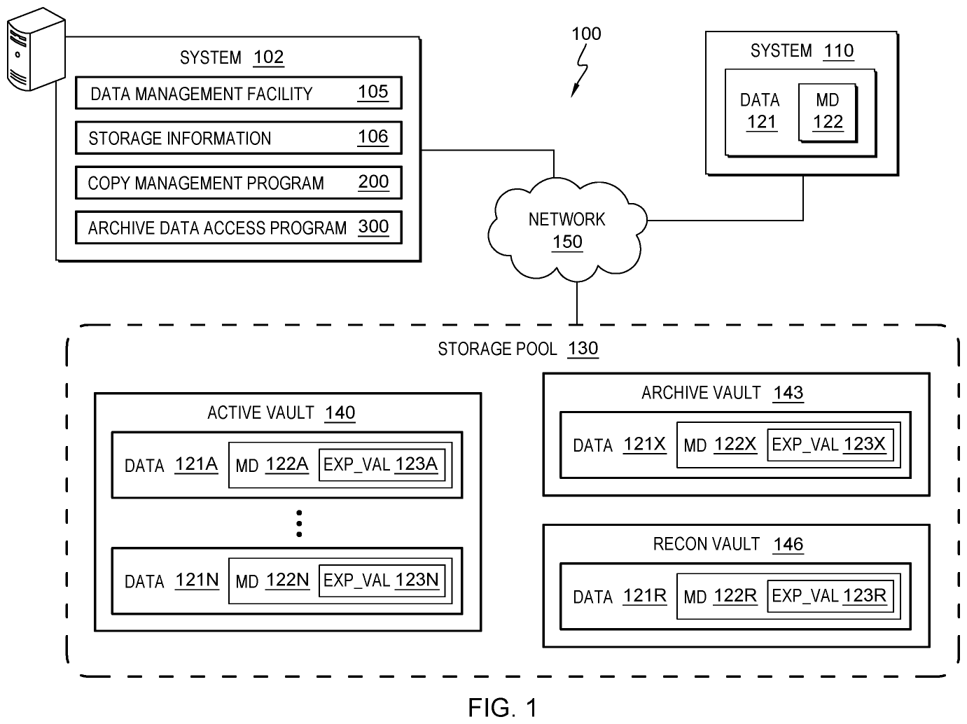

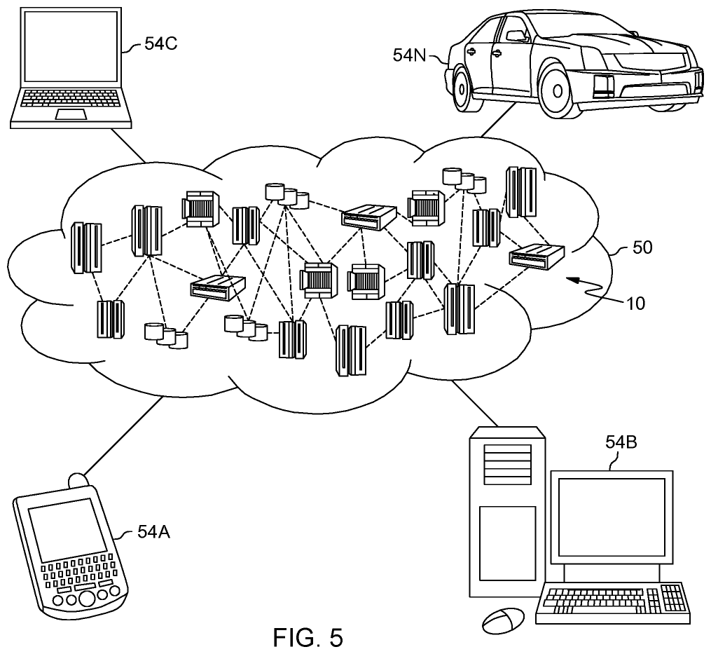

The present invention will now be described in detail with reference to the Figures. FIG. 1 is a functional block diagram illustrating a portion of a cloud computing environment, generally designated storage environment 100, in accordance with one embodiment of the present invention, such as cloud computing node 10 (discussed in further detail with respect to FIG. 5). In an embodiment, storage environment 100 includes: system 102, system 110, and storage pool 130, all interconnected over network 150.

FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

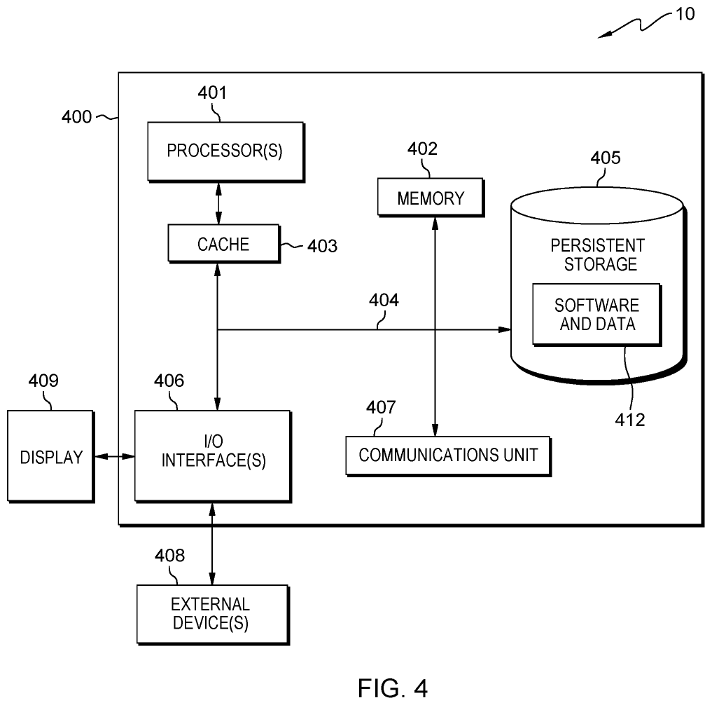

System 102 and system 110 may be laptop computers, tablet computers, netbook computers, personal computers (PC), desktop computers, or any programmable computer systems known in the art. In certain embodiments, system 102, system 110, and storage pool 130 represent computer systems utilizing clustered computers and components (e.g., database server computers, application server computers, etc.) that act as a single pool of seamless resources when accessed through network 150, as is common in data centers and with cloud-computing applications. System 102, system 110, and storage pool 130 may include components, as depicted and described in further detail with respect to FIG. 4, in accordance with embodiments of the present invention. In general, system 102, system 110, and storage pool 130 are representative of any programmable electronic device or combination of programmable electronic devices capable of executing machine-readable program instructions and communicating via network 150.

System 102 includes: data management facility 105, storage information 106, copy management program 200, and archive data access program 300. System 102 also includes various programs, such as a web interface; system management software, visualization software; network communication programs; (not shown). In an embodiment, system 102 is representative of one or more computing systems within a cloud computing system. In various embodiments, commands and actions executed or initiated by system 102 are transmitted to storage pool 130 and performed by other computing systems within storage systems and/or storage nodes of storage pool 130.

Data management facility 105 includes a suite of server-side functions that enables system 102 to administer and manage the plurality of data and storage systems within storage pool 130. In one embodiment, data management facility 105 includes functions that can aggregate and analyze data and report received from storage pool 130, a facility for users to create and/or modify storage profiles included within storage information 106, interface with and monitor various aspects of network 150, etc. In one example, data management facility 105 may track network activity, identify connectivity issues and map multi-path network communications, and determine network connection bandwidths and latencies. In another example data management facility 105 can obtain data from and/or issue commands to storage pool 130, such as determining internal input/output (I/O) activity associated with a storage system or a storage node; dictate execution of one or more file/object management functions, such as PUTCOPY, DELETE_ALL, delete, edit metadata, etc.

Storage information 106 includes information associated with storage pool 130 and a user that utilizes storage pool 130. In an embodiment, information related to a storage information 106 may include configuration and profile information related to a plurality of users, the availability data, a physical (e.g., geographic) location, configuration information related to the storage system, etc., of storage pool 130.

In one embodiment, configuration information related to storing data for a user may include one or more namespaces associated with a user; the number and type of vaults utilized by a user; configuration information corresponding to a vault, such as resource allocations and action thresholds; a list of data assigned to a vault, snapshots identifying data stored within a vault, a default number of fanout copies of new data to create within an active vault; a default expiration duration value; utilization of expiration duration tiering (e.g., differing expirations duration value among tiers, a percentage of fanout copies corresponding to a tier); etc.

In some embodiments, a profile and/or a set of preferences is associated with a user and can included more granular information related to data storage and fanout copy utilization than is included within a configuration related to a user to storage pool 130. Profile and preferences associated with a user may include; a number of fanout copies respectively associated with a type of object or data, such as a database; a number of fanout copies corresponding to a particular object; one or more expiration duration values related to a type of data or a particular object; a performance-based number of fanout copies; etc. In a further embodiment, a profile and/or preferences associated with a user can also include information related to aspects of a configuration for storing data, such as whether to utilize a default number of fanout copies, a performance-based number of fanout copies, or a number of fanout copies based on a resource constraints; etc.

Copy management program 200 is a program that creates and manages (e.g., dispositions) fanout copies of data of a user that is included within an active vault of a user. In one embodiment, copy management program 200 identifies new data within an active vault of a user and creates a number of fanout copies of the data based on information within storage information 106 related to the user. In an embodiment, copy management program 200 identifies new data within active vault 140 by at least comparing a prior snapshot of information and data stored within active vault 140 and a current snapshot of information and data stored within active vault 140. In addition to creating a number of fanout copies within an active vault of the user, copy management program 200 assigns an expiration duration value to the created fanout copies of the data.

In some embodiments, copy management program 200 can assign differing (e.g., tiered) expiration duration values among the fanout copies within the active vault. In various embodiments, copy management program 200 modifies metadata corresponding to a fanout copy of the data to include an expiration duration parameter, assign an expiration duration value, protect a fanout copy from a data management command, designate a fanout copy for archival, etc.

In another embodiment, responsive to determining that one or more fanout copies of the data expire, copy management program 200 dispositions the expired fanout copies of the data. Copy management program 200 dispositions expired fanout copies of the data by designating one fanout copy for archiving and deleting the remaining expired fanout copies of the data. In one scenario, copy management program 200 archives a fanout copy to an archive vault of a user. In another scenario, copy management program 200 modifies metadata corresponding to the designated archive fanout copy to create a non-expiring (e.g., persistent) copy of the data within the active data vault of a user.

In a further embodiment, copy management program 200 can respond to constraints and/or dictates related to storage pool 130, system 102, and/or a set of preferences or a profile related to a user, such as assigning a different expiration duration value, creating a different number of fanout copies of the new data, dynamically modifying metadata information and values, etc.

Archive data access program 300 enables a user to access data that was archived by creating a copy of the data within a RECON vault of the user. In one embodiment, archive data access program 300 determines that the archived data is stored within an archive vault configured for the user. In another embodiment, archive data access program 300 determines that the archived data is stored within an active vault configured for the user (e.g., the archived data is protected expiring). In various embodiments, archive data access program 300 assigns an expiration duration value to the copy of the archived data created within the RECON vault configured for the user. Archive data access program 300 may assign an expiration duration value to the copy of the data within the RECON vault that differs from the original expiration duration value assigned to the fanout copies of the data when the data resided within an active vault configured for the user. Responsive to the expiration duration value expiring for the copy of the data within the RECON vault, archive data access program 300 dispositions (e.g., deletes) the data within the RECON vault.

In an embodiment, storage pool 130 is representative of a cloud object storage system that includes a plurality of storage nodes and/or storage systems (not shown). For example, storage pool 130 may include network-attached storage (NAS) systems or devices, storage area networks (SANs), and/or DSNs. A storage node may refer to: a software-defined storage node; a segment of a storage system, such as drawer, a modular unit, a rack, etc.; a rack-mounted storage system; a storage library; a direct-access storage subsystem within a computing system; etc.

In various embodiments, storage pool 130 stores data for a plurality of user and can be configured to support various architectures and filesystems, such as data vaults, namespaces, data replication, data mirroring, etc. In the illustrative embodiment of FIG. 1, storage pool 130 includes active vault 140, archive vault 143, and RECON vault 146 respectively associated with the user. In another embodiment, storage pool 130 includes active vault 140, and RECON vault 146 respectively associated with the user. In other embodiments, storage pool 130 includes other vaults associated with the user.

In some embodiments, various functions of data management facility 105 are duplicated as client-side functions within the storage nodes and/or storage systems (not shown) of storage pool 130. Some client-side functions can upload data and reports to system 102 for aggregation, analyses, and use within determination by copy management program 200 and/or archive data access program 300. For example, the storage nodes and/or storage system of storage pool 130 can monitor internal input/output (I/O) activity, such as rates, amounts of data, rates of data, etc.; execute file/object management functions, such as PUTCOPY, DELETE_ALL, delete, a edit metadata, etc.; and track network traffic, connectivity, and connection bandwidth and latencies.

In an embodiment, a PUTCOPY action is equivalent to migrating data from one location to another location (e.g., transfer from one device, system, or node to another device, system or node). In an embodiment, a DELETE_ALL action for data or an object deletes all instance of the data or the object within one or more logical locations, such as a vault, unless metadata corresponding to an instance of the data or the object precludes the DELETE_ALL action from affecting the particular instance of the data or the object. In an example, if a metadata parameter value related to a DELETE_ALL action for a particular object is set to “NO” or “OFF”, then the particular object is protected or excluded from the DELETE_ALL action.

In one embodiment, active vault 140 is a user-defined collection data stored within one logical container that includes active and/or in-process data. In an embodiment, active vault 140 includes data 121A through data 121N. In one scenario, data 121A is identified as “new” data or another version of data 121 of system 110. With respect to this scenario, data 121B through data 121N represent fanout copies of data 121A.

In various embodiments, data 121A through data 121N include respective metadata (MD) 122A through MD 122N. In some embodiments, MD 122A through MD 122N includes metadata differing from MD 122 corresponding to data 121 of system 110. In an embodiment, MD 122A through MD 122N include respective instances of exp_val 123 that represent an expiration duration value respectively assigned an instance of data 121A through data 121N. In an example, copy management program 200 updates the respective instances of MD 122A through MD 122N to include respective instances of exp_val 123 (i.e., exp_val 123A through exp_val 123N). In other embodiments, MD 122A through MD 122N includes or are modified to include other metadata parameters, such as a copy index parameter and value, a “delete_all” parameter and value, etc. Instances of MD 122 also include a timestamp related to the creation of the fanout copies of data 121 within active vault 140.

In an embodiment, archive vault 143 is representative of another vault related to the user. Data within archive vault 143 may be protected from a DELETE_ALL command issued from system 102. Archive vault 143 can be utilized by copy management program 200 and/or archive data access program 300. In one embodiment, archive vault 143 stores non-expiring data (e.g., persistent data) created by a PUTCOPY action executed on an instance of data 121 within active vault 140. In some embodiments, data (e.g., data 121X) within archive vault 143 can be deleted by the user of system 110. In various embodiments, data 121X includes metadata 122X and associated exp_val 123X.

RECON vault 146 is representative a different vault configured for a user. In one embodiment, RECON vault 146 is a vault configured for reconstructing data and/or data slices of the user that are stored within storage pool 130. In some embodiments, RECON vault 146 is utilized by archive data access program 300 in addition to reconstructing data and/or data slices of the user. In a different embodiment, RECON vault 146 is another vault configured for use by archive data access program 300 to utilize and/or modify an archived instance of data 121 (e.g., data 121X of archive vault 143 or a designated archive copy of data 121 within active vault 140). In various embodiment, RECON vault 146 temporarily stores data 121R. Data 121R includes metadata 122R and associated exp_val 123R.

In one embodiment, system 102 communicates through network 150 to system 110 and storage pool 130. Network 150 can be, for example, a local area network (LAN), a telecommunications network (e.g., a portion of a cellular network), a wireless local area network (WLAN), such as an intranet, a wide area network (WAN), such as the Internet, or any combination of the previous and can include wired, wireless, or fiber optic connections. In general, network 150 can be any combination of connections and protocols that will support communications between system 102 and system 110 and storage pool 130, in accordance with embodiments of the present invention. In various embodiments, network 150 operates locally via wired, wireless, or optical connections and can be any combination of connections and protocols (e.g., personal area network (PAN), near field communication (NFC), laser, infrared, ultrasonic, etc.).

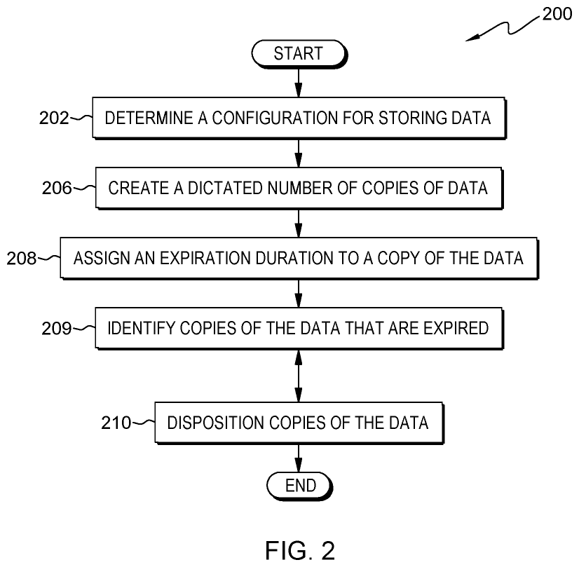

FIG. 2 is a flowchart depicting operational steps for copy management program 200, a program for creating and dispositioning fanout copies of data within storage environment 100, in accordance with embodiments of the present invention. In some embodiments, a plurality of instances of copy management program 200 can execute concurrently to create and disposition fanout copies of other data and objects associated with the user and/or data and objects of other users.

In step 202, copy management program 200 determines a configuration for storing data. In an embodiment, copy management program 200 determines a configuration for storing data associated with a user based on configuration information and user preferences (e.g., a user profile) stored within storage information 106. In one example, copy management program 200 determines a number of vaults that are configured for a user, one or more namespaces associated with a user, a number of fanout copies of data to create, an expiration duration value assigned to fanout copies, assigning tiers of expiration duration values and a number of fanout copies of the data corresponding to each expiration duration tier, etc. In another example, copy management program 200 utilizes a prior snapshot of data stored within active vault 140 to identify new data within active vault 140.

In some embodiments, copy management program 200 determines additional information related to aspects of a configuration for storing data, such as user profile and/or user preference information. In one example, copy management program 200 determines additional information related to whether to utilize a default number of fanout copies, a performance-based number of fanout copies, or a number of fanout copies based on a resource constraints, and other information and values previously discussed with respect to storage information 106.

In step 206, copy management program 200 creates a dictated number of copies of data. In an embodiment, copy management program 200 creates a dictated number of copies of data by determining that data 121A within vault 140 is new data. In one scenario, new data refers to data migrated or copied into active vault 140. In another scenario, new data refers data created or modified within active vault 140 by a computer program or a user action. In some scenarios, new data is data within active vault 140 that does not appear in a previous snapshot of active vault 140 and is also not stored within archive vault 143 (e.g., was processed by one or more aspects of the present invention. In response, copy management program 200 creates fanout copies (e.g., data 121B through data 121N) of data 121A within active vault 140 of storage pool 130.

In one embodiment, copy management program 200 creates a dictated number of fanout copies of new data based on information associated with the user within storage information 106, such as a performance-based value (e.g., data usage) or a default number of fanout copies for a particular object. In another embodiment, copy management program 200 creates the dictated number of fanout copies plus an extra fanout copy of data 121 within active vault 140. In some embodiments, if the dictated number of fanout copies and/or creating the extra fanout copy of the data conflicts with a constraint of system 102 and/or storage pool 130, then copy management program 200 creates the constrained number of fanout copies and designates one fanout copy of the data as an archive copy of the data. For example, copy management program 200 modifying MD 122B to identify data 121B as “copy(0)” of data 121.

Still referring to step 206, in various embodiments, in response to creating a fanout copy of data 121 (e.g., data 121A), copy management program 200 also includes and/or modifies additional metadata (e.g., parameters) within MD 122 corresponding to the fanout copy of the data. For example, copy management program 200 modifies respective instances of MD 122 to include parameter exp_val 123 (e.g., an expiration duration parameter and corresponding expiration duration value), set the copy number or index value corresponding to the instance of data 121, and/or include a “delete_all” parameter and corresponding flag (e.g., value). In a further embodiment, if the usage of instances of data 121 exceeds a threshold value based on the deletion of early expiring fanout copies, copy management program 200 can create a set of new fanout copies based on a metric, such as access latency.

In step 208, copy management program 200 assigns an expiration duration to a copy of the data. An expiration duration may be based on information within storage information 106, an SLA related to a user, storage resource loading within storage pool 130, etc. In various embodiments, copy management program 200 assigns an expiration duration to one or more fanout copy of data 121 by modifying corresponding instances of MD 122. In one example, copy management program 200 assigns an expiration duration to a fanout copy of data 121 and/or the new data by modifying an expiration parameter within a corresponding instance of MD 122, such as “exp_val=” with a corresponding expiration value (e.g., exp_val 123) to a dictated expiration duration value.

In a further embodiment copy management program 200 can assign a tiered set of expiration values among the fanout copies of data 121. For example, copy management program 200 may assign a first expiration duration value to fanout copies data 121A through data 121G, and a second (e.g., different) expiration duration value to fanout copies data 121H through data 121N. Alternatively, to maintain a performance metric or comply with a constraint of storage pool 130, copy management program 200 can update respective instances of MD 122 of one or more of data 121A through data 121N.

Still referring to step 208, in some embodiments copy management program 200 designates one fanout copy of data 121 as a fanout copy for archive as opposed to assigning an expiration duration. In one scenario, copy management program 200 designates one fanout copy of data 121, such as data 121C as a copy for archive by assigning an indicator corresponding to a “non-expiring” status, or modifying to exp_val 123C of data 121C to equal zero. In another scenario, copy management program 200 designates one fanout copy of data 121, such as data 121B by updating MD 122B to include a metadata parameter of “delete_all=OFF”, “delete_all=NO”, or other applicable parameter; or identifying data 121B as “copy(0)”.

In step 209, copy management program 200 identifies copies of the data that are expired. In one embodiment, copy management program 200 determines that the fanout copies of data 121 are expired based on determining that a current referenced timestamp value (e.g., related to Greenwich mean time (GMT)) for system 102 exceeds referenced timestamp value (e.g., copy creation time) plus the expiration value within MD 122 for fanout copies of data 121 within active vault 140. In some embodiments, copy management program 200 can determine that a subset of the fanout copies of data are expired. As discussed above, copy management program 200 can determine to assign tiers (e.g., differing) of expiration durations values among the fanout copies of data 121. For example, if one or more fanout copies of data 121, other than a copy designated for archive, are not deleted in step 210, then copy management program 200 returns to step 209 to await to identify other fanout copies of data 121 that expire.

In step 210, copy management program 200 dispositions copies of the data. In one embodiment, if copy management program 200 determines that archive vault 143 was created, then copy management program 200 executes a PUTCOPY action to an instance of data 121 within active vault 140 to create data 121X within archive vault 143. Subsequently, copy management program 200 may delete all remaining fanout copies of data 121 within active vault 140. For example, in response to a successful PUTCOPY action to archive vault 143, copy management program 200 executes a DELETE_ALL action to data 121 within active vault 140.

In another embodiment, if copy management program 200 determines that archive vault 143 was not created, then copy management program 200 verifies that an instance of data 121 is designated as an archive copy that remains in active vault 140. In one scenario, copy management program 200 verifies that MD 122 corresponding to one fanout copy of data 121 includes a metadata parameter and indicator (e.g., a flag), such as “delete_all=OFF”, “delete_all=NO”, or other applicable parameter; that protects the fanout copy of data 121 from a DELETE_ALL action. In another scenario, if copy management program 200 cannot identify a fanout copy of data 121 that is designated as an archive copy, then copy management program 200 designates a fanout copy of data 121 as an archive copy of data 121 by updating an instance of MD 122 to include a metadata parameter and indicator (e.g., a flag), such as “delete_all=OFF”, “delete_all=NO”, or other applicable parameter.

Still referring to step 210, in some embodiments if storage pool 130 and/or active vault 140 does not support a DELETE_ALL action (e.g., instance of MD 122 do not include a “delete_all=_” parameter), then copy management program 200 identifies a fanout copy of data 121 designated for archive as opposed to the fanout copy instances of data 121 that are expired. For example, copy management program 200 may convert the fanout copy of data 121 to an archive copy of data 121 by modifying MD 122 corresponding to a fanout copy to include a “copy(0)” indicator, or modify exp_val 123 to equal zero. Copy management program 200 subsequently utilizes another data management feature (not shown) supported within storage pool 130 to delete the fanout copies of data 121 not designated for archive.

In other embodiments, if copy management program 200 determines that differing (e.g., tiered) expiration duration values are assigned to exp_val 123A through exp_val 123N, then copy management program 200 returns to step 209 until the next set of expired data is identified. Alternatively, if copy management program 200 determines that a performance metric is dictated, then copy management program 200 can update instances of exp_val 123 of respective instance of MD 122 for one or more instance of data 121A through data 121N prior to deleting various fanout copies of data 121 within active vault 140.

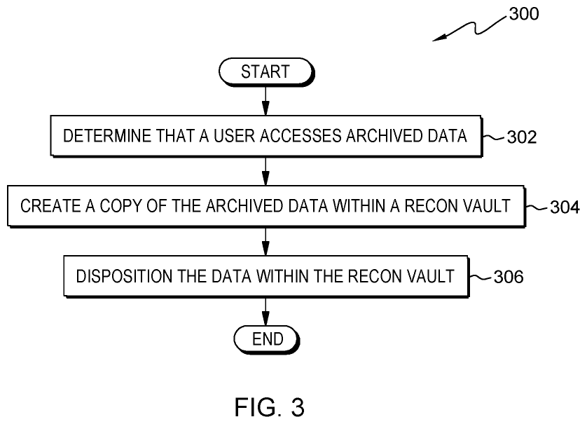

FIG. 3 is a flowchart depicting operational steps for archive data access program 300, a program that determines whether a user accesses an object stored in an archive vault, in accordance with embodiments of the present invention. In various embodiments, archive data access program 300 can copy and/or promote an archived object to one or more vaults.

In step 302, archive data access program 300 determines that a user accesses archived data. In an embodiment, archive data access program 300 determines that a user accesses data 121X within archive vault 146 by identifying user actions initiated from system 110, such as browsing a file structure, initiating an object (i.e., data) recall or reconstruction command, etc.

In step 304, archive data access program 300 creates a copy of the archived data within a RECON vault. In one embodiment, archive data access program 300 copies data 121X and corresponding MD 122X from archive vault 143 to RECON vault 146, creating data 121R and corresponding MD 122R. In another embodiment, if archive vault 143 was not created, then archive data access program 300 copies the instance of data 121 within active vault 140 that was designated as archive data to RECON vault 146, creating data 121R and corresponding MD 122R. In addition, MD 122R is updated to include the creation timestamp corresponding to data 121R. In some embodiments, archive data access program 300 terminates based one or more user actions and/or user preferences included within storage information 106. In one example, if a user executes a PUTCOPY to migrate data 121R from RECON vault 146 to system 110, then archive data access program 300 terminates.

In various embodiments, responsive to creating data 121R within RECON vault 146, archive data access program 300 modifies and/or exclude one or more parameters of MD 122X from MD 122R, such as excluding metadata parameter “delete_all=OFF”, and/or modifying exp_val 123X from a value of zero to another expiration duration value. In one scenario, archive data access program 300 updates exp_val 123R of MD 122R to include the same expiration duration value as an instance of data 121 included within active vault 140 prior to archiving. In another scenario, archive data access program 300 updates exp_val 123R of MD 122R to include a different expiration duration value. For example, the differing expiration duration value (e.g., exp_val 123R) may be set by the user or is dictated within a configuration setting within storage information 106.

In step 306, archive data access program 300 dispositions the data within the RECON vault. In one embodiment, if data 121R expires (previously discussed with respect to FIG. 2, step 209) within RECON vault 146, then archive data access program 300 deletes data 121R. In another embodiment, if data 121R expires within RECON vault 146 and data 121R was modified, then archive data access program 300 dispositions modified data 121R by archiving data 121R. In one scenario, archive data access program 300 executes a PUTCOPY action to create data 121Y and corresponding MD 122Y (not shown) within archive vault 143. In another scenario, if archive vault 143 was not created, then archive data access program 300 designates modified data 121R as an archive copy by modifying MD 122R and setting exp_val 123R to equal zero or another indicator corresponding to a non-expiring status.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

In an embodiment, FIG. 4 is representative of various computing devices associated with cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality of embodiments of the invention described herein.

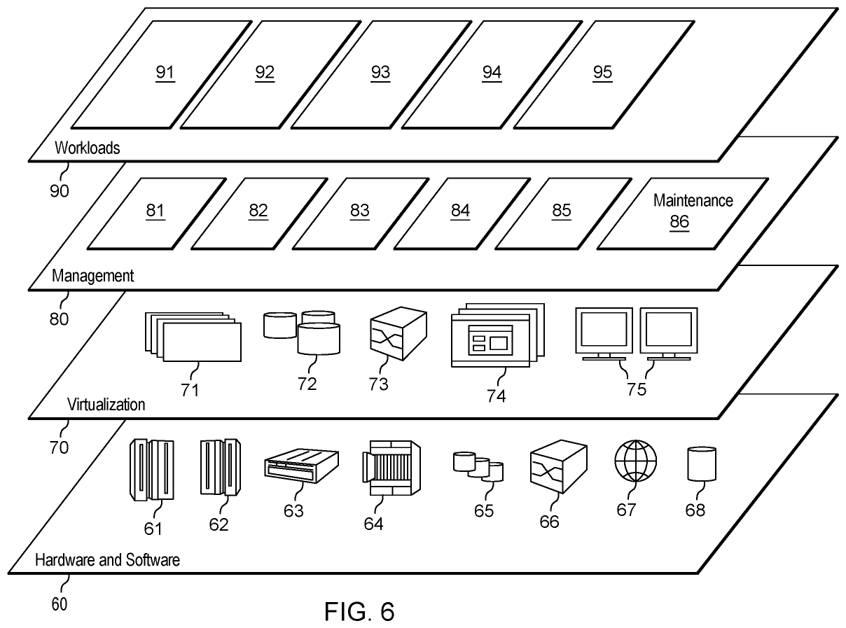

Regardless, cloud computing node 10 is capable of being implemented and/or performing any of the functionality set forth hereinabove. In example embodiments, cloud computing node 10 is representative of storage pool 130. In various embodiments, cloud computing node 10 may be representative of hardware physical instances of hardware elements and/or computing devices (e.g., RISC based servers 62, servers 63, etc.) and/or virtualized instance of hardware elements, computing devices (e.g., virtual servers 71, virtual storage 72, virtual networks 73, etc.) discussed further with respect to FIG. 6.

As shown in FIG. 4, in some embodiments computer system 400 in cloud computing node 10 is shown in the form of a general-purpose computing device. In other embodiments, computer system 400 is representative of one or more computing devices connected to cloud computing environment 50, such as system 102, system 110, and storage pool 130. Computer system 400 is an example of a system that includes software and data 412. Computer system 400 includes processor(s) 401, memory 402, cache 403, persistent storage 405, communications unit 407, input/output (I/O) interface(s) 406, and communications fabric 404.

Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random-access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 412 are stored in persistent storage 405 for access and/or execution by one or more of the respective processor(s) 401 via cache 403 and one or more memories of memory 402. With respect to system 102, software and data 412 includes storage system information 106, namespace health information 107, copy management program 200 and archive data access program 300 and other programs and data (not shown).

Communications unit 407, in these examples, provides for communications with other data processing systems or devices, including resources of system 102, system 110, and storage pool 130. In these examples, communications unit 407 includes one or more network interface cards. Communications unit 407 may provide communications, through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor. Display 409 can also function as a touch screen, such as the display of a tablet computer or a smartphone.

FIG. 5 depicts an illustrative example of cloud computing environment 50. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Instances of node 10 may communicate with one another. Instances of node 10 may be grouped (not shown) physically or virtually, in one or more networks, such as Private, Community, Public, or Hybrid clouds as described herein, or a combination thereof. This allows cloud computing environment 50 to offer infrastructure, platforms and/or software as services for which a cloud consumer does not need to maintain resources on a local computing device.

It is understood that the types of computing devices 54A-N shown in FIG. 5 are intended to be illustrative only and that instances of computing node 10 and cloud computing environment 50 can communicate with any type of computerized device over any type of network and/or network addressable connection (e.g., using a web browser). In addition, instances of cloud computing node 10 and computing devices 54A-N may include components, previously depicted and described in further detail with respect to FIG. 4, in accordance with embodiments of the present invention.

FIG. 6 depicts illustrative a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA. Maintenance 86 provides support to manage data storage vaults of a user, disposition fanout copies of data within a vault, respond to the access of data within an archive vault. In an embodiment, maintenance 86 includes at least copy management program 200 and archive data access program 300. In some embodiments, maintenance 86 utilizes other aspects of management layer 80 to monitor and control resources within virtualization layer 70.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more computer processors, data that has been added to a first data storage vault, of a set of data storage vaults, associated with a user, which is not stored in another vault;
determining, by one or more computer processors, a dictated number of copies of the data to create based on configuration information related to storing data within the set of data storage vaults;
creating, by one or more computer processors, the dictated number of copies of the data within the first vault;
assigning, by one or more computer processors, an expiration duration value to a first copy of data and the data; and
responsive to determining that the first copy data is stored within the first vault for a duration that exceeds the assigned expiration duration value, deleting, by one or more computer processors, the first copy of the data from within the first vault.

2. The method of claim 1, wherein the set of vaults includes the first vault, a second vault, and a third vault, and wherein the first vault is user-defined collection data stored within one logical container.

3. The method of claim 1, wherein the set of vaults includes the first vault and a third vault, and wherein the first vault is user-defined collection data stored within one logical container.

4. The method of claim 1, wherein assigning the expiration duration value to a copy of the data and the data further comprises:
modifying, by one or more computer processors, respective metadata of the first copy of the data and the data within the first vault to include an expiration duration parameter; and
assigning, by one or more computer processors, the expiration duration value based on information included within the configuration information related to storing data.

5. The method of claim 1, further comprising:
responsive to determining that the first copy data is stored within the first vault for the duration that exceeds the assigned expiration duration value, designating, by one or more computer processors, the data within the first vault for archiving;
determining, by one or more computer processors, whether the set of vaults includes a second vault; and
responsive to determining that the set of vaults includes the second vault, executing, by one or more computer processors, a PUTCOPY action to migrate the data to the second vault.

6. The method of claim 5, further comprising:
responsive to determining that the set of vaults does not include the second vault, modifying, by one or more computer processors, metadata corresponding to the data to designate the data as an archive copy of the data, wherein the metadata corresponding to the designated archive copy of the data includes an indicator corresponding to a non-expiring status, and wherein the designated archive copy of the data remains in the first vault.

7. The method of claim 1, wherein a vault spans multiple storage device sets and the data and copies of the data are automatically spread across all the storage device sets within a storage pool.

8. A computer program product comprising:
one or more computer readable storage media and program instructions stored on the one or more computer readable storage media, the program instructions readable/executable by one or more computer processors:
program instructions to identify data that has been added to a first data storage vault, of a set of data storage vaults, associated with a user, which is not stored in another vault;
program instructions to determine a dictated number of copies of the data to create based on configuration information related to storing data within the set of data storage vaults;
program instructions to create the dictated number of copies of the data within the first vault;
program instructions to assign an expiration duration value to a first copy of data and the data; and
responsive to determining that the first copy data is stored within the first vault for a duration that exceeds the assigned expiration duration value, program instructions to delete the first copy of the data from within the first vault.

9. The computer program product of claim 8, wherein the set of vaults includes the first vault, a second vault, and a third vault, and wherein the first vault is user-defined collection data stored within one logical container.

10. The computer program product of claim 8, wherein the set of vaults includes the first vault and a third vault, and wherein the first vault is user-defined collection data stored within one logical container.

11. The computer program product of claim 8, wherein program instructions to assign the expiration duration value to a copy of the data and the data further comprise:
program instructions to modify respective metadata of the first copy of the data and the data within the first vault to include an expiration duration parameter; and
program instructions to assign the expiration duration value based on information included within the configuration information related to storing data.

12. The computer program product of claim 8, further comprising:
responsive to determining that the first copy data is stored within the first vault for the duration that exceeds the assigned expiration duration value, program instructions to designate the data within the first vault for archiving;
program instructions to determine whether the set of vaults includes a second vault; and
responsive to determining that the set of vaults includes the second vault, program instructions to execute a PUTCOPY action to migrate the data to the second vault.

13. The computer program product of claim 12, further comprising:
responsive to determining that the set of vaults does not include the second vault, program instructions to modify metadata corresponding to the data to designate the data as an archive copy of the data, wherein the metadata corresponding to the designated archive copy of the data includes an indicator corresponding to a non-expiring status, and wherein the designated archive copy of the data remains in the first vault.

14. The computer program product of claim 8, wherein a vault spans multiple storage device sets and the data and copies of the data are automatically spread across all the storage device sets within a storage pool.

15. A computer system comprising:
one or more computer processors;
one or more computer readable storage media; and
program instructions stored on the computer readable storage media for execution by at least one of the one or more computer processors, the program instructions comprising:
program instructions program instructions to identify data that has been added to a first data storage vault, of a set of data storage vaults, associated with a user, which is not stored in another vault;
program instructions to determine a dictated number of copies of the data to create based on configuration information related to storing data within the set of data storage vaults;
program instructions to create the dictated number of copies of the data within the first vault;
program instructions to assign an expiration duration value to a first copy of data and the data; and
responsive to determining that the first copy data is stored within the first vault for a duration that exceeds the assigned expiration duration value, program instructions to delete the first copy of the data from within the first vault.

16. The computer system of claim 15, wherein the set of vaults includes the first vault, a second vault, and a third vault, and wherein the first vault is user-defined collection data stored within one logical container.

17. The computer system of claim 15, wherein the set of vaults includes the first vault and a third vault, and wherein the first vault is user-defined collection data stored within one logical container.

18. The computer system of claim 15, wherein program instructions to assign the expiration duration value to a copy of the data and the data further comprise:
program instructions to modify respective metadata of the first copy of the data and the data within the first vault to include an expiration duration parameter; and
program instructions to assign the expiration duration value based on information included within the configuration information related to storing data.

19. The computer system of claim 15, further comprising:
responsive to determining that the first copy data is stored within the first vault for the duration that exceeds the assigned expiration duration value, program instructions to designate the data within the first vault for archiving;
program instructions to determine whether the set of vaults includes a second vault; and
responsive to determining that the set of vaults includes the second vault, program instructions to execute a PUTCOPY action to migrate the data to the second vault.

20. The computer system of claim 19, further comprising:
responsive to determining that the set of vaults does not include the second vault, program instructions to modify metadata corresponding to the data to designate the data as an archive copy of the data, wherein the metadata corresponding to the designated archive copy of the data includes an indicator corresponding to a non-expiring status, and wherein the designated archive copy of the data remains in the first vault.
